(19) United States
(12) Patent Application Publication
(10) Pub. No.: US 2021/0394490 A1
(43) Pub. Date: Dec. 23, 2021

(54) FIRE-RESISTANT GLAZING

(71) Applicant: SAINT-GOBAIN GLASS FRANCE, COURBEVOIE (FR)

(72) Inventors: Marine BRUNET, PARIS (FR); François COMPOINT, PARIS (FR)

(21) Appl. No.: 16/967,985

(22) PCT Filed: Feb. 14, 2019
(86) PCT No.: PCT/FR2019/050330

§ 371 Date: Aug. 6, 2020

(30) Foreign Application Priority Data
Feb. 16, 2018 (FR) 1851336
Mar. 23, 2018 (FR) 1852537

(51) Int. Cl. B32B 17/10; C09K 21/04; C09K 21/12; B32B 27/28

(52) U.S. Cl. CPC B32B 17/10311; B32B 17/10036; B32B 17/10788; B32B 17/10798; B32B 17/10005; B32B 17/10917; B32B 2270/00; C09K 21/04; C09K 21/12; B32B 27/283; B32B 2250/40; B32B 2307/3065; B32B 17/10697

(57) ABSTRACT

A fire-resistant glazing unit includes a first untempered glass sheet, a second untempered glass sheet and a solid interlayer stack, wherein the interlayer stack includes a first intumescent layer, an essentially inorganic layer and a second intumescent layer.

The present invention relates to the field of fire-resistant glazing.

The criteria for evaluating fire-resistant glazing, which may depend on the applicable regulations and on the final application of the glazing unit, generally take account of the mechanical stability, the leaktightness and the thermal insulation capacity of the glazing. European standard EN 13501 defines three classes: E (fire stability: mechanical strength, flame resistance and ability to hold back smoke), EW (fire stability with heat radiation limit) or EI (fire stability and insulation); associated with the time, expressed in minutes (30, 60, 90, 120 and 180 minutes), during which the element in question is able to retain these properties. The present invention more particularly relates to fire-resistant glazing of the E/EW30 class and higher.

Fire-resistant glazing comprising a highly viscous aqueous solution based on hydrated alkali metal silicates sealed between two glass sheets (EP 3023245, WO 2007/118886, WO 2007/053248, EP 2072247, EP 2282889, WO 2008/053248) is known. In the event of fire, the exposed glass sheet quickly shatters. The layer of silicates which remains adhered to the second glass sheet is directly exposed to the fire. The water contained in this layer evaporates and forms bubbles, causing the expansion of the layer and giving a solid and opaque inorganic foam. The mechanical strength and heat resistant properties of this foam ensure the integrity of the second glass sheet and limit the transmission of radiation. However, this solution, particularly suited to glazing of the E/EW30 class and higher, has several drawbacks. Indeed, such glazing cannot be cut. The use of tempered glass, which is generally necessary to guarantee sufficient mechanical strength, and the sealing of the intermediate liquid layer, necessitate custom production to the desired finished dimensions. Moreover, during the aging of the glazing, the intermediate layer may tend to corrode the glass, to become hazy, or, although it is highly viscous, to creep under the effect of gravity and thereby cause optical distortions.

Other fire-resistant glazing is formed of a layer of solid hydrogel between two glass sheets, obtained by crosslinking a solution of water-soluble monomers (US 2016/2000077, EP 2330174). In the event of fire, the evaporation of the water and the inorganic additives contained in the hydrogel layer make it possible to delay the propagation of the fire. However, unlike the layer of alkali metal silicate, the hydrogel layer does not undergo any expansion and does not form an insulating foam. Moreover, such glazing generally requires the use of tempered glass sheets and consequently cannot be cut.

The aim of the present invention is to dispense with the abovementioned drawbacks by proposing a fire-resistant glazing unit, in particular of the E/EW30 class or higher, which can be cut and which does not cause any haze or optical distortions.

Thus, one aspect of the present invention relates to a fire-resistant glazing unit comprising a first untempered glass sheet, a second untempered glass sheet and a solid interlayer stack, characterized in that the interlayer stack comprises a first intumescent layer, an essentially inorganic layer and a second intumescent layer. The use of a solid interlayer stack combined with untempered glass sheets enables the production of large glazing units which can be cut to the desired dimensions. The presence of intumescent layer and inorganic layer in the interlayer stack gives the glazing unit according to the invention, in the event of fire, both sufficient mechanical strength and an ability to reduce the exchanges of heat by radiation.

The glass sheets may have a thickness which varies from 1 to 8 mm, preferably 2 to 6 mm. Advantageously, each glass sheet has the same thickness.

The glass may be a soda-lime-silica glass obtained by floating on a bath of tin (according to the “float” process), a borosilicate glass or any other type of transparent glass. It may be clear or colored glass depending on the desired esthetic finish.

The interlayer stack only comprises solid layers. The layers of the stack preferably have an amount of residual water of less than 10%, or even less than 5%, or even less than 1% by weight. In particular, the interlayer stack does not comprise a liquid layer of hydrated alkali metal silicates. Moreover, the interlayer stack preferably does not comprise glass sheets, especially between the essentially inorganic layer and the first and second intumescent layers. In other words, the glazing unit according to the invention preferably only comprises two glass sheets, that is to say only said first and second glass sheets forming the outer surfaces of the glazing unit. The interlayer stack according to the invention typically has a thickness of 0.5 mm, or even 1.0 mm, or even 2 mm to 12 mm, or even 10 mm, 8 mm, 5.0 mm or even 4.0 mm.

The interlayer stack according to the invention comprises at least one essentially inorganic layer. For the purposes of the present invention, “essentially inorganic layer” is intended to mean an inorganic or hybrid organic-inorganic layer comprising less than 40%, preferably less than 30% by weight of carbon. The essentially inorganic layer is typically based on inorganic polymer, on silicates or on a sol-gel material based on metal oxides. Examples of inorganic polymers include organopolysiloxane resins, especially based on polydimethylsiloxane. Preferably, the layers based on silicates essentially consist of dried alkali metal silicates. The sol-gel materials based on metal oxides, especially based on silica and/or titanium oxide, are typically obtained by hydrolysis/condensation of alkoxides or metal salts, especially of silicon and/or titanium, which are optionally functionalized, for example with amine, isocyanate, phosphate or fluoro groups. Preferably, the essentially inorganic layer is based on inorganic polymer, obtained for example from α,ω-difunctionalized polydimethylsiloxanes, especially those α,ω-difunctionalized with vinyl groups, which are crosslinked. The essentially inorganic layer typically has a thickness of 0.3 mm, or even 0.5 mm to 6.0 mm, 5.0 mm, 4.0 mm, 3.0 mm, or even 2.0 mm.

The interlayer stack according to the invention comprises at least two intumescent layers: an intumescent layer on each side of the essentially inorganic layer. According to a particular embodiment, the interlayer stack may also comprise a plurality of intumescent layers, for example two, three or four, on each side of the essentially inorganic layer, the number of intumescent layers preferably being identical on each side of the essentially inorganic layer. Each intumescent layer typically has a thickness of 0.01 to 1.0 mm, preferably 0.02 to 0.8 mm, more preferentially 0.05 to 0.5 μm. In the case of a single intumescent layer on each side of the essentially inorganic layer, these generally have a thickness of 0.1 to 1.0 mm, preferably 0.1 to 0.8 mm. On the other hand, in the case of a plurality of intumescent layers on each side of the essentially inorganic layer, these have a smaller thickness, generally of 0.01 to 0.5 mm, preferably 0.05 to 0.3 mm.

The intumescent layers have the property of foaming under the effect of temperature, typically at temperatures greater than 100° C., or even greater than 180° C., for example between 200 and 400° C., to reach at least three times, preferably at least five times, or even at least eight times or even at least ten times their initial thickness.

The first and second intumescent layers may be in direct contact with the essentially inorganic layer. For the purposes of the present invention, an element A “in direct contact” with an element B means that there is no other element arranged between said elements A and B. On the other hand, an element A “in contact” with an element B does not exclude the presence of another element between said elements A and B. Alternatively, a connecting layer, especially based on silanes, may be arranged between the first and second intumescent layers and the essentially inorganic layer. This connecting layer makes it possible to improve the adhesion of the intumescent layers to the essentially inorganic layer.

In a particular embodiment, the interlayer stack may also comprise a reinforcing layer between the essentially inorganic layer and each of the first and second intumescent layers. The reinforcing layers make it possible to improve the fire resistance of the intumescent layer. The interlayer stack thus preferably comprises a first intumescent layer (or a plurality of intumescent layers), a first reinforcing layer, an essentially inorganic layer, a second reinforcing layer, and a second intumescent layer (or a plurality of intumescent layers). The reinforcing layers are typically layers based on silicates or on a sol-gel material based on metal oxides, especially on silica and/or titanium oxide. They typically have a thickness of 0.1 μm, or even 0.5 μm, 1 μm, or even 2 μm to 100 μm, or even 50 μm, 20 μm, or even 10 μm. In this embodiment, the essentially inorganic layer is preferably based on inorganic polymer, especially based on organopolysiloxane resins such as resins based on polydimethylsiloxane.

In the case of pluralities of intumescent layers on each side of the essentially inorganic layer, each intumescent layer on one side of the essentially inorganic layer is separated from the adjacent intumescent layer by a secondary essentially inorganic layer. The secondary essentially inorganic layers, which are identical or different, may be as defined above for the essentially inorganic layer. They are preferably based on silicates or on a sol-gel material based on metal oxides, especially on silica and/or titanium oxide. The secondary essentially inorganic layers may be in direct contact with the intumescent layers juxtaposed therewith. Alternatively, a connecting layer, especially based on silanes, may be arranged between the intumescent and the secondary essentially inorganic layers in order to improve their adhesion. The secondary essentially inorganic layers typically have a thickness of 0.1 to 20 μm, preferably 1 to 10 μm.

Each intumescent layer typically comprises a binder and an intumescent agent. The binder may be organic, inorganic or hybrid.

When the binder is an organic binder, it may be a thermoplastic binder, a thermosetting binder or a mixture thereof. Examples of organic binders include homopolymers or copolymers derived from monomers or comonomers chosen from vinyl monomers, diene monomers, isocyanate monomers, epoxide monomers, dicarboxylic acid monomers, polyol monomers, polyamine monomers, and mixtures thereof. The vinyl monomers include in particular ethylene, propylene, isobutene, isoprene, vinyl chloride, vinylidene chloride, styrene, vinyltoluene, acrylonitrile, vinyl esters and acrylic monomers. Examples of vinyl esters include in particular C1-C12 vinyl carboxylates and vinyl acrylates such as vinyl acetate, vinyl propionate, vinyl butyrate, vinyl isobutyrate, vinyl valerate, vinyl hexanoate, vinyl 2-methylhexanoate, vinyl 2-ethylhexanoate, vinyl isooctanoate, vinyl nonanoate, vinyl decanoate, vinyl laurate, vinyl palmitate, vinyl stearate, vinyl neodecanoate and vinyl versatates with 9 to 11 carbon atoms (also referred to as VeoVa for vinyl ester of versatic acid). Acrylic monomers (or acrylates) is intended especially to mean alkyl (alk)acrylate or alkyl (alk)acrylic acid compounds such as methyl methacrylate, ethyl methacrylate, methyl acrylate, ethyl acrylate, methacrylic acid, acrylic acid, n-butyl acrylate, isobutyl acrylate, t-butyl acrylate, n-butyl methacrylate, isobutyl methacrylate, t-butyl methacrylate, 2-ethylhexyl methacrylate, 2-ethylhexyl acrylate, dodecyl methacrylate, dodecyl acrylate, cyclohexyl acrylate, cyclohexyl methacrylate, and acrylate compounds containing a hydroxy function such as 2-hydroxyethyl methacrylate, hydroxypropyl methacrylate, 2-hydroxyethyl acrylate and hydroxypropyl acrylate. The diene monomers include in particular 1,3-butadiene. The isocyanate monomers include in particular hexamethylene diisocyanate, isophorone diisocyanate, methylenebis(4-cyclohexylisocyanate), 2,4-toluene diisocyanate, 2,4′-dibenzyl diisocyanate, 2,4′-methylenediphenyl diisocyanate, m-xylylene diisocyanate, 2,6-toluene diisocyanate, 4,4′-dibenzyl diisocyanate, 4,4′-methylenediphenyl diisocyanate and 2,2′-methylenediphenyl diisocyanate. The epoxide monomers include in particular epichlorohydrin, epibromohydrin, isopropyl glycidyl ether, butyl glycidyl ether, allyl glycidyl ether, 1,4-butanediol diglycidyl ether (1,4-bis (2,3-epoxypropoxy)butane), ethylhexyl glycidyl ether, methyl glycidyl ether, neopentyl glycol diglycidyl ether, ethylene glycol diglycidyl ether, glycerol diglycidyl ether, glycidol and glycidyl methacrylate. The dicarboxylic acid monomers include in particular oxalic acid, malonic acid, succinic acid, glutaric acid, adipic acid, pimeric acid, suberic acid, azelaic acid, sebacic acid, phthalic acid, isophthalic acid, terephthalic acid, maleic acid and fumaric acid. The polyol monomers include in particular ethylene glycol, propylene glycol, butane-1,4-diol, glycerol, trimethylolpropane, pentaerythritol and sorbitol. The polyamine monomers include in particular ethylenediamine, propane-1,3-diamine, butane-1,4-diamine, pentane-1,5-diamine, hexamethylenediamine, 1,2-diaminopropane, diphenylethylenediamine and 1,2-diaminocyclohexane. Preferred organic binders include polyethylenes, poly(vinyl acrylates), poly(vinyl chlorides), poly(vinyl acetates), polystyrenes, ethylene/vinyl acetate copolymers, ethylene/vinyl ester copolymers, vinyl acrylate/vinyl acetate copolymers, vinyl acetate/ethylene/vinyl ester copolymers, styrene/acrylate copolymers, vinyltoluene/acrylate copolymers, styrene/butadiene copolymers, vinyltoluene/butadiene copolymers, styrene/acrylonitrile copolymers, vinyltoluene/acrylonitrile copolymers and polyester/polyurethane copolymers. Particularly preferred organic binders include copolymers based on ethylene and on one or more vinyl esters, such as ethylene/vinyl acetate copolymers and ethylene/vinyl acetate/vinyl ester, especially C9-C11 vinyl versatate, terpolymers. In some embodiments, the binder may also comprise phosphorus-based functions in order to improve the fire resistance thereof.

The binder is preferably transparent. Transparent binder is intended to mean a binder having a total light transmission of greater than 85% and a haze of less than 15%, measured with a hazemeter according to standard ASTM D1003-00 with illuminant C, when said binder is applied then dried and/or crosslinked on a glass substrate in a layer of approximately 300 μm.

Intumescent agent is intended to mean a compound or a mixture of compounds which reacts and/or decomposes under the effect of temperature, essentially releasing noncombustible gases. In other words, the intumescent agent is a compound or a mixture of thermally degradable compounds which decomposes or is activated especially at temperature in the vicinity of the softening point of the organic binder, typically at temperatures of greater than 100° C., for example between 150 and 400° C.

The intumescent agent is preferably chosen from thermally degradable nitrogenous compounds, thermally degradable carboxylic acids and mixtures thereof. Examples of thermally degradable nitrogenous compounds include thermally degradable amides such as urea and thermally degradable cyanamides such as melamine, guanidine and dicyandiamide, and also ammonium, amine, amide and cyanamide salts of phosphoric, polyphosphoric or phosphonic acids. Examples of thermally degradable carboxylic acids include thermally degradable polycarboxylic acids such as oxalic acid, malonic acid, malic acid, tartaric acid, tartronic acid, maleic acid, citric acid, tricarballylic acid, 1,2,3,4-butanetetracarboxylic acid and inorganic or organic salts thereof, especially ammonium salts, amine salts, amide salts and cyanamide salts. The intumescent agent is preferably chosen from citric acid, ammonium phosphate, urea or mixtures thereof. The intumescent layers typically comprise 5 to 40% by weight of intumescent agent.

The intumescent layers may also comprise fillers, especially inorganic or organometallic fillers, such as particles of silica (especially colloidal silica), silicates, sol-gel metal oxide precursors or coupling agents based on silanes. The intumescent layers typically comprise from 1% or even 2% to 60%, or even 50%, 40%, 20%, or even 15% by weight of fillers.

They may also comprise 1 to 15%, preferably 1 to 10% by weight of a flame retardant. The flame retardant is preferably chosen from boron compounds and organophosphorus compounds. Examples of boron compounds include boric acid or borax. Examples of organophosphorus compounds include phosphonates such as diethyl ethylphosphonate or dimethyl methylphosphonate.

The interlayer stack may be in direct contact with the first and second glass sheets. Alternatively, a holding layer may be arranged between the interlayer stack and each of the first and second glass sheets. Thus, in a particular embodiment, the glazing unit according to the invention comprises a first glass sheet, a first holding layer, a first intumescent layer (or a plurality of intumescent layers), optionally a first reinforcing layer, an essentially inorganic layer, optionally a second reinforcing layer, a second intumescent layer (or a plurality of intumescent layers), a second holding layer and a second glass sheet. The holding layers are preferably based on silicates or on a sol-gel material based on metal oxides, especially on silica and/or titanium oxide. They typically have a thickness of 1 μm, or even 2 μm, or 5 μm to 100 μm, or even 50 μm, 20 μm, or even 10 μm.

Each layer of the stack is preferably transparent, such that the interlayer stack typically has a total light transmission of greater than 85% and a haze of less than 15%, measured with a hazemeter according to standard ASTM D1003-00 with illuminant C.

The glazing unit according to the invention is preferably symmetrical, that is to say that the succession of layers from the first glass sheet to the essentially inorganic layer is identical to the succession of layers between the second glass sheet and the essentially inorganic layer. Indeed, the glazing unit generally advantageously has identical fire resistance characteristics on each side.

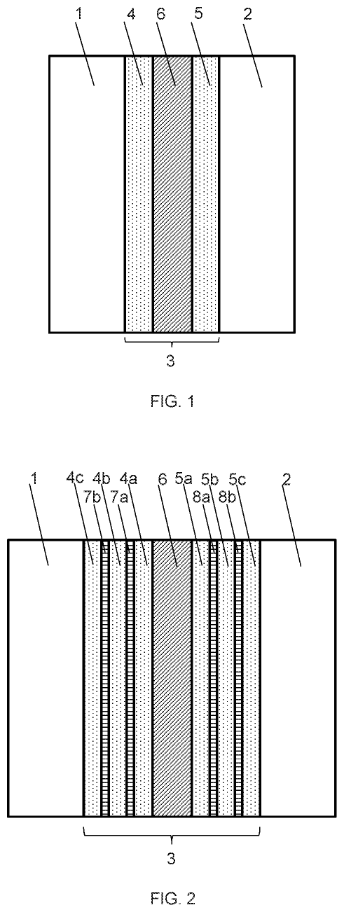

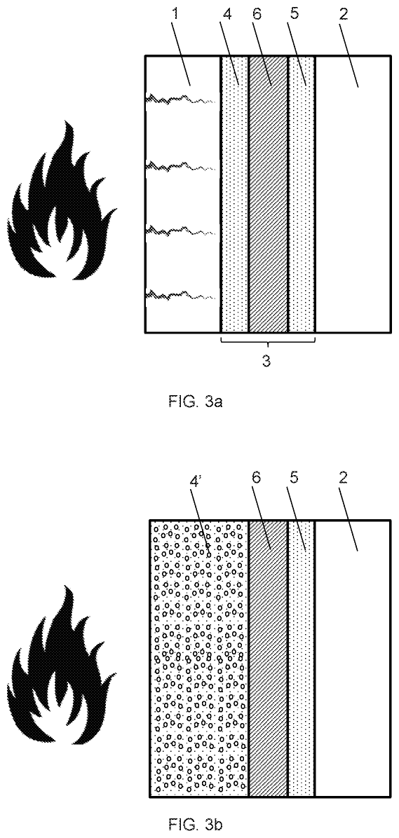

FIGS. 1 and 2 illustrate two embodiments of the fire-resistant glazing unit according to the invention. The interlayer stack (3) is arranged between the first glass sheet (1) and the second glass sheet (2). It comprises a first intumescent layer (4, 4a) and a second intumescent layer (5, 5a) on either side of an essentially inorganic layer (6). In the embodiment of FIG. 1, the stack comprises a single intumescent layer (4, 5) on each side of the essentially inorganic layer (6). In the embodiment of FIG. 2, the stack comprises a plurality of intumescent layers (4a, 4b, 4c and 5a, 5b, 5c) on each side of the essentially inorganic layer (6). The intumescent layers (4a, 4b, 4c and 5a, 5b, 5c) are separated from one another by secondary essentially inorganic layers (7a, 7b and 8a, 8b).

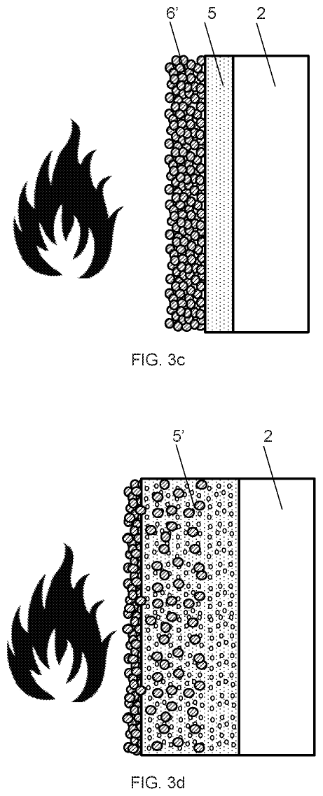

FIGS. 3a to 3d illustrate the behavior of the glazing unit according to the invention in the event of fire. Confronted with the rise in temperature, the fire-side glass sheet (1) quickly shatters, exposing the first intumescent layer (4) (FIG. 3a). The first intumescent layer (4) quickly foams up under the effect of the heat to give an opaque foam (4′) serving as first barrier to radiation, and delaying the transfer of heat to the opposite side of the glazing unit. The integrity of the glass sheet (2) on the side opposite to the fire is thus preserved by avoiding a sharp rise in temperature in the first moments of exposure of the glazing unit to the fire. The foam (4′) exposed directly to the fire is quickly degraded, in particular when it is formed of an organic matrix. The use of a plurality of intumescent layers separated by thin secondary essentially inorganic layers, as shown in FIG. 2, has the advantage of forming a foam loaded with inorganic elements, which will be more slowly degraded when faced with fire, thereby improving the fire resistance properties of the glazing unit. The combustion of the foam (4′) exposes the essentially inorganic layer (6). This layer, which degrades at high temperature, firstly acts as a barrier to the fire and forms an inorganic calcination residue (6′), providing mechanical strength and integrity of the glazing unit. The second intumescent layer (5), protected by the first intumescent layer and the essentially inorganic layer, is subjected to a gradual rise in temperature promoting gradual, complete and homogeneous foaming up. The foam (5′) obtained may at least partially encompass the inorganic calcination residue (6′). The presence of an optional reinforcing layer (not shown) makes it possible to promote the inclusion of inorganic elements by the foam (5′) during the foaming up of the second intumescent layer (5). This foam (5′), loaded with inorganic elements, provides resistance and integrity of the glazing over the duration. In particular, it enables the second glass sheet (2) to be held in the event of it cracking. The presence of an optional holding layer (not shown) in contact, or even in direct contact, with the glass sheet (2) makes it possible to improve the preservation of the integrity of the glass sheet (2) on the side opposite to the fire.

An example of a process for manufacturing the fire-resistance glass according to the invention is described below. This process comprises providing a first glass sheet and a second glass sheet, and assembling the first and second glass sheets with an interlayer stack arranged between them, said interlayer stack comprising a first intumescent layer, an essentially inorganic layer and a second intumescent layer.

The assembly of the glass sheets with the interlayer stack may be carried out by any suitable technique. The different layers may be deposited successively on the first glass sheet before being assembled with the second glass sheet. Alternatively, the assembly of the glass sheets with the interlayer stack comprises the deposition of the first intumescent layer on the first glass sheet, the deposition of the second intumescent layer on the second glass sheet, and the assembly of the glass sheets thus coated with the essentially inorganic layer.

The intumescent layers are preferably deposited by wet deposition techniques, for example by spray coating, curtain coating, flow coating or roller coating. The essentially inorganic layer may be deposited by roller coating, curtain coating, by spraying or by pouring. During the pouring, the coated glass sheets are arranged substantially parallel to one another and kept at a distance from one another, for example by means of a spacer frame, to form a cavity. The cavity is filled by gravity or by injection with a composition of precursors of the essentially inorganic layer. The assembly formed by the coated glass sheets is preferably arranged on an inclined plane or placed in the vertical position so as to avoid the presence of air in the essentially inorganic layer. A seal is generally applied to the edge of said sheets, over the entire periphery thereof, leaving an opening in the thickness of the seal to allow the space between the coated glass sheets to be filled. The secondary essentially inorganic layers, when present, like the holding layers and the reinforcing layers, are preferably deposited by roller application or by spraying, given their greater thinness.

The first and second intumescent layers may be obtained from an aqueous dispersion of binder, especially an organic polymeric binder as defined above, comprising the intumescent agent and optional fillers. It typically has a solids content of 40 to 60% by weight. A step of drying and/or crosslinking may be necessary after the deposition of the intumescent layers, typically at temperatures of 20 to 80° C. for 5 minutes to 24 hours, preferably for 5 to 20 minutes.

The essentially inorganic layer may be obtained from a composition of precursors. In a first particular embodiment, the composition of precursors may be an aqueous solution of alkali metal silicates, typically having a solids content of 30 to 70%. After application, the layer is dried, preferably at temperatures of 20 to 80° C. for 10 min to 24 h, in order to obtain a layer of silicates. In another particular embodiment, the composition of precursors is a composition comprising a polysiloxane, a crosslinking agent and optionally a catalyst. The polysiloxane is preferably an α,ω-difunctionalized polydimethylsiloxane, especially functionalized with vinyl groups. The crosslinking agent is preferably a siloxane monomer such as methylsiloxane or dimethylsiloxane. The catalyst may be chosen from tin catalysts. The composition typically has a solids content of 80 to 100% by weight. After application, the layer is preferably dried and/or crosslinked, typically at temperatures of 20 to 80° C. for 10 to 120 minutes. In another embodiment, the composition of precursors comprises metal salts or alkoxides, especially of silicon and/or of titanium, which are optionally functionalized, for example with amine, isocyanate, phosphate or fluoro groups. The composition typically has a solids content of 20 to 80%. After application, the composition is polymerized and dried, preferably at temperatures of 20 to 80° C. for 10 min to 24 h, in order to obtain a layer of sol-gel material.

The invention is illustrated with the help of the following nonlimiting examples.

### EXAMPLES

A fire-resistant glazing unit I1 according to the invention, as illustrated in FIG. 1, was prepared from two untempered annealed glass sheets of 2.5 mm thickness. An intumescent layer of 500 μm thickness was deposited on each of the glass sheets from an aqueous dispersion comprising a polymeric binder based on vinyl acetate, vinyl ester and ethylene, diethyl ethylphosphonate, ammonium phosphate, urea and citric acid. After drying the intumescent layer, the two glass sheets thus coated are arranged parallel to one another, with the intumescent coatings facing each other, and assembled using a peripheral seal forming a cavity of 1 mm thickness between the two glass sheets. A composition of precursors based on vinyl-terminated polymethylsiloxane, methylsiloxane and a tin catalyst is poured by gravity until the cavity is entirely filled. This composition is crosslinked at 60° C. for 1 h to form the essentially inorganic layer.

A fire-resistant glazing unit I2 according to the invention was prepared from two untempered annealed glass sheets of 2.5 mm thickness. A holding layer based on alkali metal silicates was deposited on each of the glass sheets over a thickness of 5 μm. An intumescent layer of 100 μm thickness was deposited on each of the holding layers from an aqueous dispersion comprising a polymeric binder based on vinyl acetate, vinyl ester and ethylene, diethyl ethylphosphonate and citric acid. After drying the intumescent layer, a reinforcing layer based on sol-gel silica is deposited on the intumescent layer with a thickness of 5 μm. After drying the reinforcing layer, the two glass sheets thus coated are arranged parallel to one another, with the intumescent coatings facing each other, and assembled using a peripheral seal forming a cavity of 1 mm thickness between the two glass sheets. A composition of precursors based on vinyl-terminated polymethylsiloxane, methylsiloxane and a tin catalyst is poured by gravity until the cavity is entirely filled. This composition is crosslinked at 60° C. for 1 h to form the essentially inorganic layer.

1. A fire-resistant glazing unit comprising a first untempered glass sheet, a second untempered glass sheet and a solid interlayer stack, wherein the interlayer stack comprises a first intumescent layer, an essentially inorganic layer and a second intumescent layer, and wherein the interlayer stack has a haze of less than 15%.

2. The glazing unit as claimed in claim 1, wherein the interlayer stack has a total light transmission of greater than 85%.

3. The glazing unit as claimed in claim 1, wherein the interlayer stack does not comprise a glass sheet.

4. The glazing unit as claimed in claim 1, wherein the essentially inorganic layer is a solid layer based on inorganic polymer, on silicates or on a sol-gel material based on metal oxides.

5. The glazing unit as claimed in claim 1, wherein the essentially inorganic layer has a thickness of 0.3 to 6.0 mm.

6. The glazing unit as claimed in claim 1, wherein the first and second intumescent layers comprise a binder and an intumescent agent.

7. The glazing unit as claimed in claim 6, wherein the binder is an organic binder chosen from homopolymers or copolymers derived from monomers or comonomers chosen from vinyl monomers, diene monomers, isocyanate monomers, epoxide monomers, dicarboxylic acid monomers, polyol monomers, polyamine monomers and mixtures thereof.

8. The glazing unit as claimed in claim 6, wherein the intumescent agent is chosen from thermally degradable nitrogenous compounds, thermally degradable carboxylic acids and mixtures thereof.

9. The glazing unit as claimed in claim 1, wherein the first and the second intumescent layer have a thickness of 0.01 to 1.0 mm.

10. The glazing unit as claimed in claim 1, wherein the first and the second intumescent layer comprise fillers.

11. The glazing unit as claimed in claim 1, wherein a holding layer is arranged between the interlayer stack and each of the first and second glass sheets.

12. The glazing unit as claimed in claim 11, wherein the holding layers are layers based on silicates or on a sol-gel material based on metal oxides.

13. The glazing unit as claimed in claim 1, wherein a reinforcing layer is arranged between the essentially inorganic layer and each of the first and second intumescent layers.

14. The glazing unit as claimed in claim 13, wherein the reinforcing layers are layers based on silicates or on a sol-gel material based on metal oxides.

15. The glazing unit as claimed in claim 1, wherein the interlayer stack comprises a plurality of intumescent layers on each side of the essentially inorganic layer, the pluralities of intumescent layers being separated from one another by secondary essentially inorganic layers.

16. The glazing unit as claimed in claim 5, wherein the essentially inorganic layer has a thickness of 0.3 to 3.0 mm.

17. The glazing unit as claimed in claim 10, wherein the fillers are inorganic or organometallic fillers.

18. The glazing unit as claimed in claim 12, wherein the holding layers are layers of silica and/or titanium oxide.

19. The glazing unit as claimed in claim 14, wherein the reinforcing layers are layers of silica and/or titanium oxide.
